(19) United States
(12) Patent Application Publication
(10) Pub. No.: US 2009/0000696 A1
(43) Pub. Date: Jan. 1, 2009

(54) Planer

(75) Inventors: Horst Grossman, Hunfelden (DE); Stefan Sell, Mainz (DE)

Correspondence Address: THE BLACK & DECKER CORPORATION, 701 EAST JOPPA ROAD, TW199, TOWSON, MD, 21286, US

(73) Assignee: BLACK & DECKER INC., Newark, DE (US)

(21) Appl. No.: 12/143,261

(22) Filed: Jun. 20, 2008

(30) Foreign Application Priority Data
Jun. 22, 2007 (GB) GB0712130.4

(51) Int. Cl. B27C 1/10

(52) U.S. Cl. 144/117.4

(57) ABSTRACT

A planer (102) has a housing (104) with a shoe (138) and an aperture (136) in the shoe The planer includes a motor (112) mounted adjacent to the aperture in the shoe, a stator non-rotatably mounted to the housing, and a rotor arranged substantially coaxially around the stator and adapted to rotate relative to said stator. The planer also includes a battery that is located above the shoe. A pair of blades (132) are mounted for rotation with the rotor and protrude through the aperture to engage and to remove surface material from a workpiece.

This application claims priority to UK Patent Application No. GB0712130.4 filed Jun. 22, 2007. The entire contents of that application are expressly incorporated herein by reference.

### TECHNICAL FIELD

The present invention relates to a powered hand held planer.

### BACKGROUND

A known type of hand held planer for removing the surface of a workpiece such as a wooden door is shown in FIG. 1. The planer 2 has a housing 4 having a rear handle 6, provided with a trigger switch 8 for supplying electrical power via a power supply cable 10 to an electric motor 12, and a front handle 14. A shoe 16 having a part-cylindrical recess 19 is mounted to and flush with the bottom 20 of the housing 4. A planer cylinder 22 having a pair of diametrically opposed blades 24 is rotatably mounted in a recess 19 so that the surface of the planer cylinder 22 protrudes slightly from the recess 19 through an aperture 18 in the underside of the shoe 16 in order to engage a workpiece (not shown) when the planer 2 rests on the workpiece. The motor 12 has an output shaft 26 which is connected via a drive belt 28 to the planer cylinder 22 such that the planer cylinder 22 is driven at lower rotational speed and higher torque than the output shaft 26 of the motor 12. When the planer cylinder 22 is driven by the motor 12 via the belt 28, the blades 22 contact and remove material from the surface of the workpiece.

Existing planers of the type shown in FIG. 1 suffer from a number of drawbacks. In particular, because the planer cylinder 22 is driven by means of a belt 28 which engages an end of the planer cylinder 22, the belt 28 is generally located outside of the housing 4 in order to enable the planar cylinder 22 to extend the full width of the housing 4. The externally mounted belt 28 therefore presents an obstacle to effective use of the planer 2 in certain confined spaces conditions, such as at the edge of a floor adjacent to a wall. In addition, planers of this type are relatively bulky, and this problem is exacerbated if an attempt is made to power the planer by means of batteries, since any battery pack would need to be located on the rear of the housing 4, because of insufficient space in the housing 4 due to the housing 4 having to contain the planer cylinder 22 and motor 12.

GB2299051 discloses a typical hand held planer.

EP1428620 discloses a hand held planer having a motor upon which is mounted a fan. The fan generates an airflow which is directed, via passageways within the housing, towards the cutting drum where it entrains debris generated by the rotating cutting drum and moves it away from the cutting drum, inside the housing, before expelling it from the side of the housing.

### SUMMARY

According to an aspect of the present invention, there is provided a battery powered hand held planer comprising:—

a housing having workpiece engaging surface for engaging a workpiece, and an aperture in said workpiece engaging surface;

a motor mounted adjacent said aperture and comprising a stator non-rotatably mounted to the housing and a rotor arranged substantially coaxially around said stator and adapted to rotate relative to said stator when electrical power is supplied to the motor;

at least one blade mounted for rotation with said rotor and adapted to at least partially protrude from said aperture to engage a workpiece such that rotation of said rotor relative to said stator causes the or each blade to remove surface material from a workpiece; and

a rechargeable battery wherein the battery is adapted at least partially to be located above the workpiece engaging surface.

By providing a motor comprising a stator non-rotatably mounted to the housing and a rotor adapted to rotate relative to the stator when electrical power is supplied to the motor, and at least one blade mounted for rotation with the rotor, this provides the advantage that the or each blade of a planer can be directly driven by the motor, as a result of which no drive belt needs to be provided externally of the housing. This therefore enables the planer to be used in more confined situations than is possible with known designs of planer. In addition, because the blades are mounted for rotation with the rotor of the motor, for example on a planer cylinder or roller, the planer cylinder to which the blades are mounted does not need to be spaced from the motor, as a result of which the combination of the motor and planer cylinder is of more compact construction. This in turn provides the advantage that the space occupied by the motor in the known design of planer can be used to accommodate a battery, and therefore enables the planer to be battery powered without increasing its bulkiness. Furthermore, because the planer blades are mounted for rotation with the rotor, the full width of the planer cylinder carrying the blades can be used to accommodate magnets of the motor, as a result of which greater motor torque can be achieved.

In one embodiment, the whole of the battery is mounted above the workpiece engaging surface. By enabling the battery to be mounted either partially or totally above the workpiece engaging surface and/or mounted either partially or totally within the housing, it enables the length of planer to be reduced. A further advantage is that it is easier to arrange the battery's location so that its weight can counter balance the weight of the motor in order to enable the centre of gravity to be located below the actuator (or any other desired position). The or each said blade may be mounted to an external surface of the rotor. The planer may further comprise a handle on the housing and an actuator adjacent said handle for supplying electrical power to the motor, wherein the centre of gravity of the planer is located below said actuator when the planer is held by and supported by said handle. This provides the advantage that when the planer is held by the handle, the bottom surface of the housing is arranged generally horizontally, as a result of which the planer can be easily placed onto a workpiece in a flat orientation, which minimises damage to the workpiece. The planer may further comprise a rechargeable battery. The battery may be adapted to be received at least partially inside of the housing rearwardly of the motor. Ideally, it is totally enclosed with the housing. This provides the advantage of enabling a compact construction of the planer. By combining the planer cylinder with the motor, space can be generated within the housing where the battery can be accommodated. In existing designs of battery powered planers, the battery attaches to the rear of the housing. The rotor may include a plurality of ribs on an internal surface thereof to generate an airflow within the motor. This provides the advantage of assisting in cooling of the motor.

The planer may further comprise a fan mounted to the motor to generate an airflow to cool the motor and/or move debris created by the cutting action of the rotating blade away from the rotor. The airflow from the fan can be directed so that it entrains the debris created by the cutting action of the blade and moving it away from the blade either internally through passageways in the housing, or externally. In an embodiment, the rotor comprises a substantially cylindrical drum and a plurality of permanent magnets attached to the inside of the drum. The permanent magnets may be sintered rare earth magnets. The motor may be a brushless shielded motor. The stator may be a claw pole stator comprising at least one claw pole stator element.

In an embodiment, at least one said claw pole stator element comprises:
(i) a field coil;
(ii) a first half-claw member comprising a first central element and a plurality of claws arranged in equi-angular intervals around the perimeter of the first half-claw member; and
(iii) a second half-claw member comprising a second central element and a plurality of claws arranged in equi-angular intervals around the perimeter of the second half-claw member; wherein the claw pole stator element is formed when the first half claw member and the second half claw member are joined at the first central element and the second central element thereby causing the claws to juxtapose about the perimeter of the first half-claw member and the second half-claw member, the claws enclosing the field coil and, the field coil surrounding the joined first central element and second central element.

The first half-claw member and the second half-claw member may be formed of an isotropic ferromagnetic composite material. The claw pole stator may further comprise a shaft and a plurality of claw pole stator elements coaxially disposed on the shaft. The shaft may be formed of a non-magnetic material. The stator may comprise a laminated core having a plurality of laminated teeth, a field coil, and a shaft, wherein the laminated core is fixedly secured on the shaft.

### BRIEF DESCRIPTION OF THE DRAWINGS

FIG. 1 is a cross sectional elevation view of a known planed power planer;

FIG. 2 is a cross section elevation view of a battery powered planer embodying the present invention;

FIG. 3 is an exploded view of the planer of FIG. 2 with the upper part of the housing removed

FIG. 4 shows an exploded perspective view of a claw pole motor comprising two assembled and one disassembled claw pole stator elements, a motor shaft and an external rotor drum;

FIG. 5 shows a front elevation view of a half-claw member;

FIG. 6 shows a front elevation view of a half-claw member and field coil;

FIG. 7 shows a cross-sectional view A-A of the half-claw member and field coil shown in FIG. 6;

FIG. 8 shows a cross-sectional view of one stator element comprising two half-claw members joined to enclose a field coil;

FIG. 9 shows a front elevation view of a rotor drum;

FIG. 10 shows a side elevation view of a rotor drum;

FIG. 11 shows a cross-sectional view of a claw pole motor comprising rotor drum including end faces with bearings and three stator elements mounted upon a shaft;

FIG. 12 shows a perspective view of a stator comprising three stator elements; and

FIG. 13 shows an exploded perspective view of a laminated motor comprising a laminated core stator and an external rotor drum.

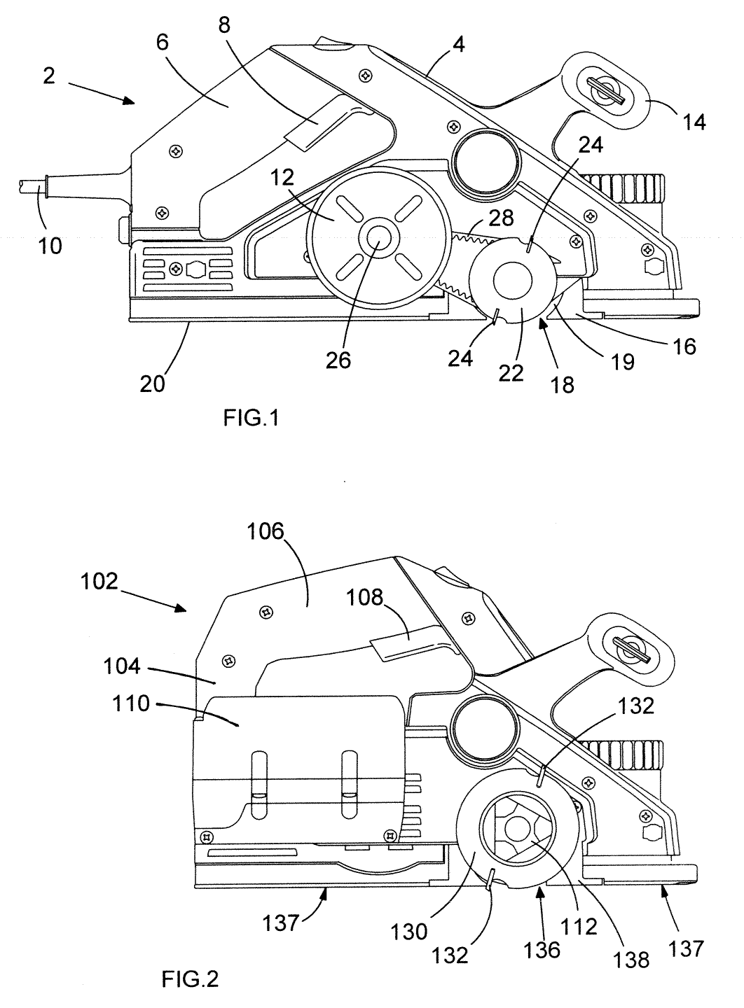

### DETAILED DESCRIPTION

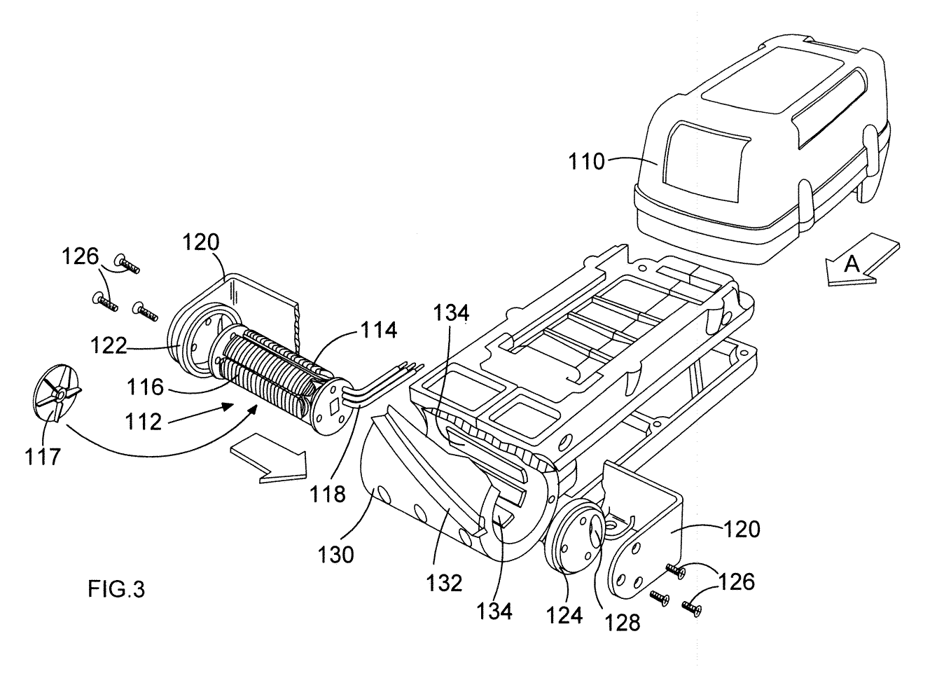

A battery hand held powered planer 102 embodying the invention is shown in FIGS. 2 and 3. The planer 102 has housing 104 defining a rear handle 106 having a trigger switch 108 for supplying electrical power from a rechargeable battery 110 to an electric motor 112, and comprising a workpiece engaging surface 137 which rests against a workpiece when the planer is in use.

As shown in greater detail in FIG. 3, the motor 112 is a brushless type motor and has a central stator 114 carrying field windings 116 which are energised via leads 118 connected to battery 110 via an electronic power module (not shown) controlling the timing of energizing of the field windings 116. The stator 114 is fixed to a bracket 120 on the housing 104 via end caps 122, 124 and screws 126 such that the stator 114 is non-rotatably mounted relative to the housing 104. One of the end caps 124 has an elongate aperture 128 for allowing connection of the leads 118 to the electronic power module.

The motor 112 also comprises a rotor 130 in the form of a planer cylinder coaxially arranged around the stator 114 and having a pair of planer blades 132 on its outer surface and permanent magnets 134 arranged around its inner surface. Part of the outer surface of the planer cylinder 130 protrudes through an aperture 136 in a shoe 138 in the lower surface of the housing 104 such that when the field windings 116 on the stator 114 are energised, the rotor 130 rotates relative to the stator 114 and the housing 104 and the blades 132 engage a workpiece on which the planer 102 rests to remove surface material from the workpiece.

The battery 110 is slidably mounted in the housing 104 above the workpiece engaging surface 137 in the direction of arrow A in FIG. 3, and the weight of the various component parts is so distributed that when the planer 102 is held by the rear handle 106, the centre of mass of the planer 102 hangs vertically below the trigger switch 108. In particular, the position of the battery has been arranged so that the weight of the battery counterbalances the weight of the motor. In this way, the planer 102 can be conveniently placed on a workpiece with the shoe 138 and lower workpiece engaging surface 137 of the housing 104 arranged parallel to the workpiece. In this way, a user can easily place the planer 102 on a workpiece with minimum discomfort to the user or risk of damage to the workpiece. It can be seen that the battery 110 occupies the space within the housing 104 occupied by the motor in known types of belt driven planers, as a result of which the front to back length of the planer 102 of the present invention is less than that of known battery powered belt driven planers. Furthermore, it can be seen in FIG. 2 that the battery 110 is located above the workpiece engaging surface 137.

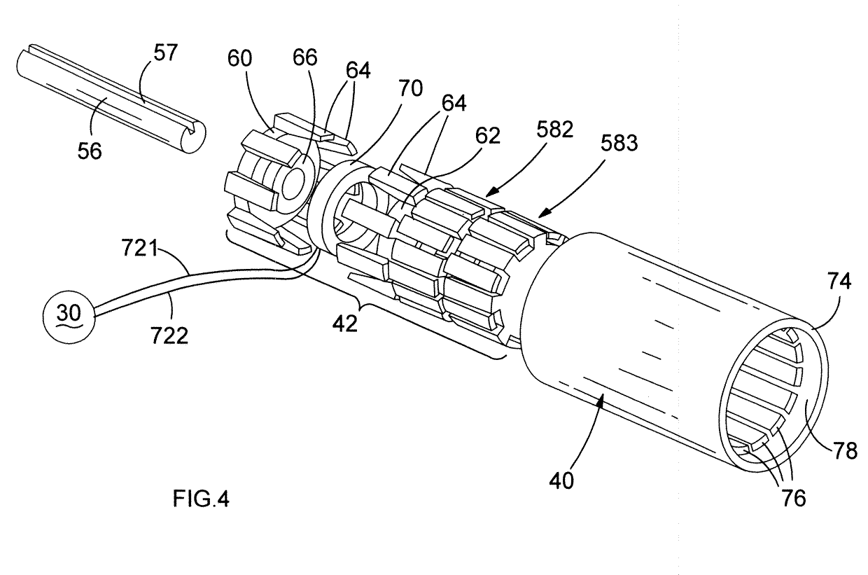

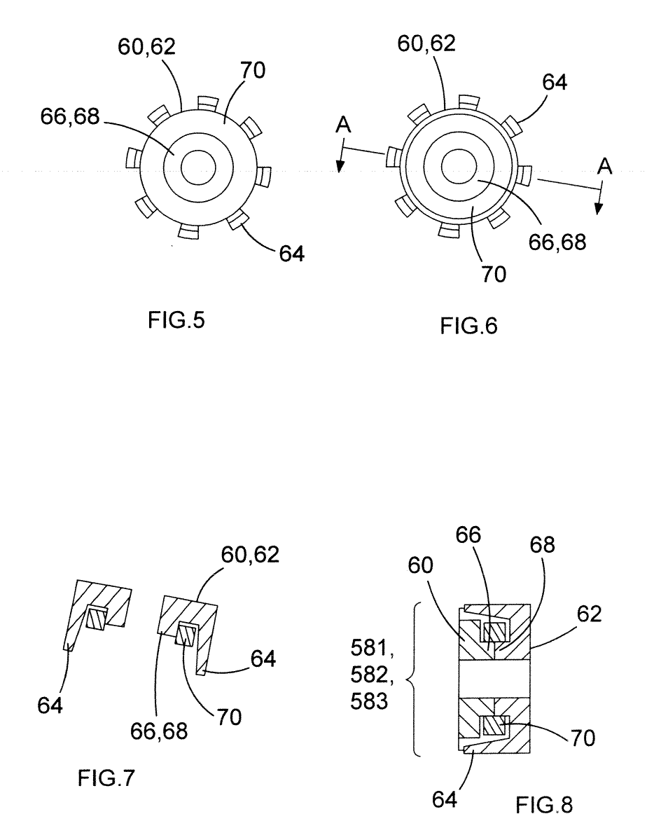

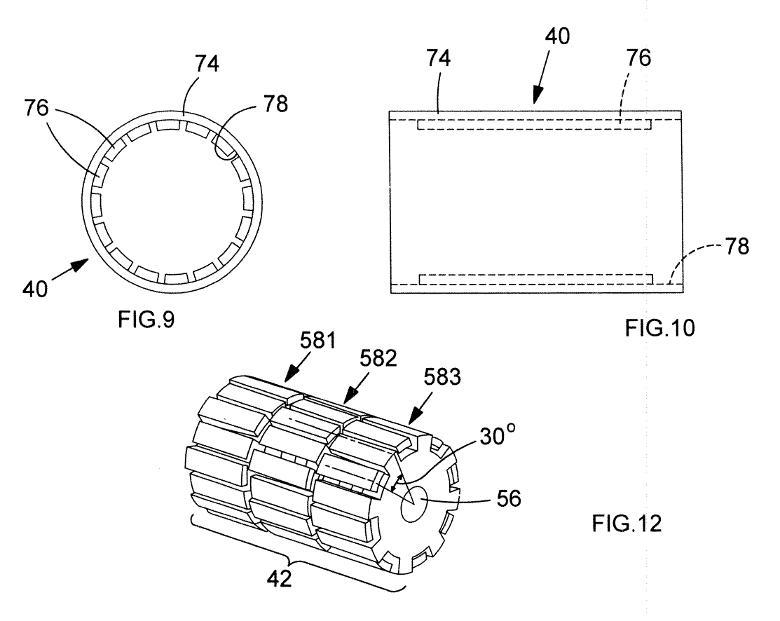

A claw pole motor is one possible choice of electric motor. Electrical machines with claw pole armatures are well known and offer high specific torque output using very simple and easily manufactured coils and soft magnetic components. An example of a claw pole motor for use in the planer 102 of FIGS. 2 and 3 is now described with reference to FIGS. 4 to 12. The claw pole motor 112 comprises:

a stator 42, comprising a central shaft 56 with a channel 57 and three electrically independent claw pole stator elements 581,582,583, each stator element comprising:

a substantially circular first half-claw member 60 having a first central element 66 and eight claws 64;

a substantially circular second half-claw member 62 having a second central element 68 and eight claws 64;

both half-claw members 60,62 being substantially the same, but opposing, and the eight claws 64 of each half-claw member 60,62 being arranged in equi-angular intervals around the perimeter of the substantially circular half-claw members 60,62, such that when the first central element 66 and the second central element 68 are joined together the claws 64 juxtapose each other, thereby forming an outer cylindrical drum of sixteen axially aligned claws 64;

a field coil 70 of insulated copper wire, preferably formed in the shape of a simple hoop, the field coil 70 being situated within the cylindrical space enclosed by the sixteen juxtaposed claws 64 and surrounding the central elements 66,68 of the two joined half-claw members 60,62. The field coil 70 is insulated from the half-claw members 60,62 and is connected to the power module 30 by two field coil wires 721,722 which exit an assembled claw pole stator element 581,582,583 via a gap between two claws 64, or through a hole in one of the central elements 66,68;

a rotor drum 40 comprising a cylindrical drum 74 with a circular end face 75,77 at each end and sixteen permanent magnets 76. Each end face 75,77 comprises a bearing 79,81) mounted upon the shaft 56 and a plurality of fins 83 disposed on the outside of the end face 75,77. The cylindrical drum 74 is supported by the end faces 75,77 and bearings 79,81 for rotational movement about the shaft 56. Sixteen magnetic poles are formed by the sixteen permanent magnets 76, each permanent magnet 76 being attached to the inner surface 78 of the cylindrical drum 74 and extending continuously along its axial length.

The half-claw members 60,62 are made of a ferromagnetic material. The preferred choice of material for the half-claw members 60,62 is a composite of soft iron powder, the soft iron powder being pre-coated in an insulating epoxy resin and held together by a bonding process to produce an isotropic ferromagnetic material. The first stage of this process is the compression of the soft iron powder composite into a mould shaped like a half-claw member. At this stage the powder is not yet bonded together and the half-claw member formed within the mould would disintegrate if removed from the rigid confines of the mould. The next stage of the process involves heating the powder to a temperature at which the epoxy resin fuses thereby linking together the soft iron powder particles. The final stage of the bonding process involves the soft iron powder composite cooling to a temperature at which the epoxy resin solidifies thereby permanently and solidly bonding the soft iron powder particles together into the shape of a half-claw member. A half-claw member 60,62 made of this type of soft iron composite benefits from a significant reduction in the iron losses caused by eddy currents, when compared to the solid mild steel structures commonly used for conventional claw pole cores. This is due to the epoxy resin forming an insulating layer between soft-iron powder particles which acts as a barrier inhibiting the circular flow of eddy currents that would normally be formed by an alternating magnetic field within the body of the half-claw members 60,62. Overall, the extremely low iron loss due to eddy currents is comparable to that of laminated steels, however claw pole members 60,62 made from laminated steel would be more difficult and therefore more costly to make than one made of the soft iron composite.

Construction of a claw pole stator element 581,582,583 begins with the assembly of two half-claw members 60,62 so that they are joined at their central elements 66,68 and reversed in such a way that their claws 64 juxtapose but do not touch each other, the claws 64 enclosing a cylindrical space occupied by the field coil 70. At this stage of assembly the half-claw members 60,62 are only held together by an assembly device (not shown) and, before progressing further, provision must be made for an exit point for the field coil wires 721,722 leading from the field coil 70 to the power module 30. The preferred means for uniting the two half-claw members 60,62 and field coil 70 is by a process called ‘potting’. Potting of a claw pole stator element 581,582,583 involves impregnation of all air gaps between the two half-claw members 60,62 and field coil 70 with a liquid resin, the resin later solidifying and hardening to rigidly bond these parts together. Once the potting process has been completed the assembly device can be removed because the bond formed by the solidified resin is strong enough to hold the claw pole stator element 581,582,583 permanently intact.

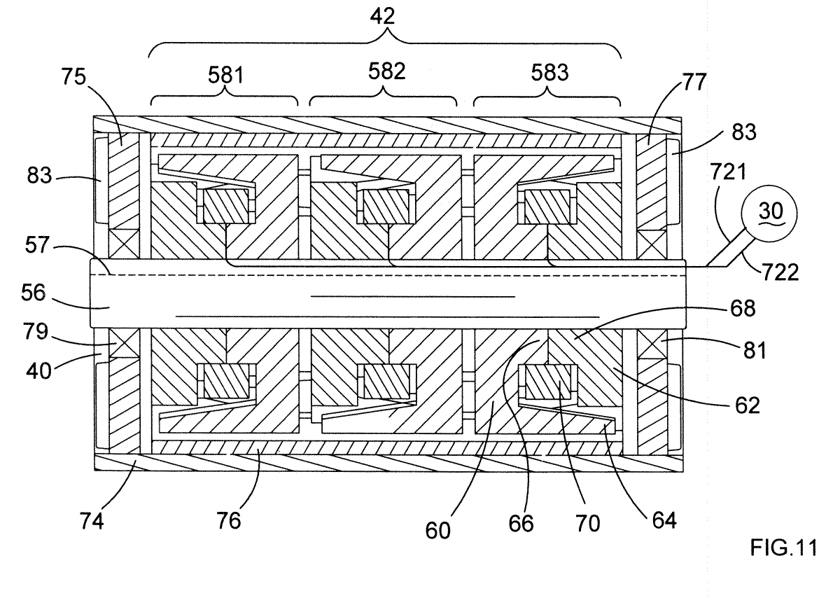

The stator 42 of the claw pole motor comprises three substantially identical claw pole stator elements 581,582,583, each one fixedly and concentrically disposed upon a shaft 56, the shaft 56 preferably being formed of non-magnetic material so as to minimise magnetic flux leakage between adjacent claw pole elements 581,582,583. The channel 57 extends along the full length of the shaft 56. The channel 57 is sufficiently wide and deep to provide a passage for the field coil wires 721,722 between the claw pole stator elements 581,582,583 and the exterior of the claw pole motor. The channel 57 is sealed at one end by a plug (not shown). The channel 57 is sealed at the other end by a rubber gland, or the like, (not shown) where the field coil wires 721,722 exit the channel 57. The plug and gland prevent entry of foreign particulate matter into the interior of the claw pole motor via the channel 57. In the embodiment shown in FIG. 11 the channel is arranged upon the surface of the shaft 56. However the channel 57 may be in the form of an internal channel or passage extending along the full length of the centre of the shaft 56. Each of the sixteen magnetic poles of a claw pole stator element 581,582,583 is misaligned by 30° (about the axis of the shaft 56) relative to the equivalent magnetic pole of the neighbouring claw pole stator element 581,582,58), and this alignment gives the stator 42 a ‘stepped’ appearance. The stepped alignment of the three claw pole stator elements 581,582,583 relative to each other, as described above, effectively results in the stator 42 having a total of forty-eight magnetic poles (3×16 magnetic poles), meaning that the permanent magnets 76 of the rotor drum 40 travel less rotational distance between magnetic poles of the stator 42 than they would if the sixteen magnetic poles of each of the three claw pole stator elements 581,582,583 were located in-line. The battery 110, when supplied to the stator elements 581,582,583, produces a rotating magnetic field within the stator 42 capable of turning the rotor drum 40 with a very low level of cogging, this due to diminished rotational distance between the magnetic poles of the stator 42. ‘Cogging’ is a term used to describe non-uniform movement of the rotor such as rotation occurring in jerks or increments, rather than smooth continuous motion. Cogging arises when the poles of a rotor move from one pole of the stator to the next adjacent pole and is most apparent at low rotational speeds.

The cylindrical drum 74, end faces 75,77 and bearings 79,81 collectively surround the inner space of the rotor drum 40 in an air-tight manner such that the stator elements 581,582,583 and permanent magnets 76 are shielded from the entry of foreign particulate matter. During operation of the planer 102 the fins 83 rotate with the end faces 75,77 and cylindrical drum 74 about the central shaft 56 to create additional air-flow in the region of the rotor drum 40 to cool the rotor drum 40 and its internal components. Furthermore, the cylindrical drum 74 is axially fixed along its full length with respect to the shaft 56 by the end faces 75,77 and bearings 79,81 located at each end. The end faces 75,77 and bearings 79,81 prevent axial loads applied to the exterior of the rotor drum 40 from axially deflecting any part of the rotor drum 74 towards the shaft 56, thus preventing damaging rubbing contact between the stator elements 581,582,583 and the rotating permanent magnets 76. The cylindrical drum 74 is also longitudinally fixed with respect to the shaft 56 by the end faces 75,77 and bearings 79,81. However, longitudinal forces applied to the rotor drum 40 are likely to be smaller than axial forces applied to the rotor drum 40 during use of the planer 102.

The electric motor of a power tool may be directly driven by a domestic mains electrical supply or a battery electrical supply. However, power tools, like for example a wood planer, frequently use a power module to drive its electric motor in order to benefit from better control and efficiency that a power module may provide. Power modules capable of receiving a domestic mains electrical supply or a battery electrical supply and converting it into dc or ac, single phase or multiple phase supply, suitable for powering various types of electric motors are well known to the skilled person in the art.

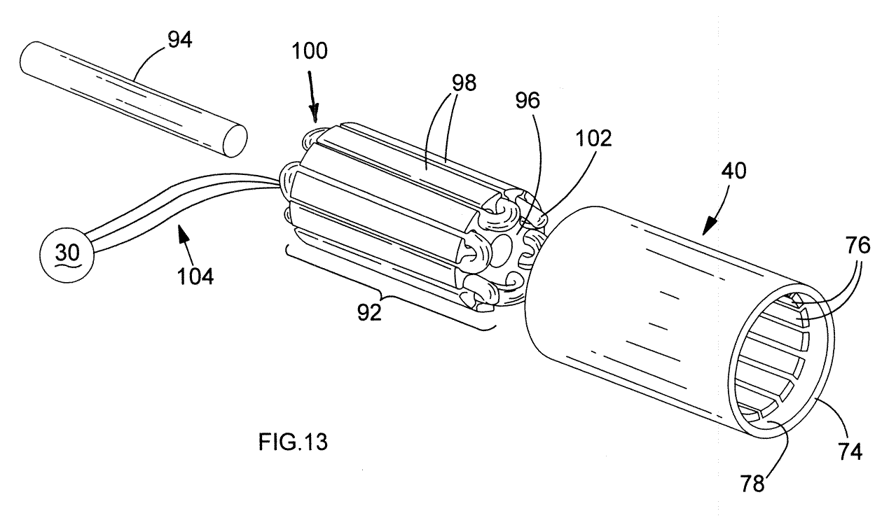

As will be apparent to the person skilled in the art other electric motors may be used as an alternative to the claw pole motor. Referring to FIG. 13, a laminated core motor is shown that could be directly substituted for the claw pole motor as described herein above. The laminated core motor comprises: a stator 92 centrally mounted upon a shaft 94, the stator 92 comprising a laminated core 96 with twelve teeth 98 and an insulated field coil 100, the field coil 100 further comprising; six independent and insulated field coils 102, the independent field coils 102 being wound alternately around the twelve laminated core teeth 98, each independent field coil 102 receiving an electrical supply via its respective field coil wire 104; a rotor drum 40, comprising a cylindrical drum 74 and sixteen magnetic poles formed by sixteen permanent magnets 76. Each permanent magnet 76 is attached to the inner surface 78 of the cylindrical drum 74 and extends continuously along its axial length.

The laminated stator 92 has twelve teeth 98 and therefore twelve magnetic poles, arranged to produce a rotating magnetic field when the six independent field coils 102 are supplied with electrical supply from the power module 30. The rotating magnet field urges the permanent magnets 76 of the rotor drum 40 to turn about the stator 92. The laminated stator 92 is skewed by one half tooth pitch in order to minimise cogging.

The laminated motor is similar to the claw pole motor in that it comprises an internal stator 92, rigidly connected to the body element 20 on one side, and an external rotor drum 40. Although not shown in FIG. 13, the rotor drum 40 of the laminated core motor may further comprise a circular end face 75,77 with a bearing 79,81 at each end, and a plurality of fins 83 disposed upon the outside of each circular end face 75,77, like the claw pole motor. Both are brushless shielded motors, with an internal stator 40,92 about which turns substantially the same external rotor drum 40. The claw pole motor is one preferred choice of electric motor for this invention because of its simple and inexpensive construction.

Regardless of the specific design of motor 112, a fan 117 such as, for example, an impeller may be mounted on and driven by the motor. The air flow generated by the fan can be used to cool the motor. In addition or alternatively, the air flow can be used to remove debris generated by the cutting action of the planer cylinder 130 by entraining the debris, and moving it away from the workpiece being cut. The airflow and entrained debris can pass through passageways within the housing or be expelled externally of the housing.

It will be appreciated by person skilled in the art that the above embodiments have been described by way of example only, and not in any limitative sense, and that various alterations and modifications are possible without departure from the scope of the invention as defined by the appended claims.

What is claimed is:

1. A battery powered hand held planer comprising:
a housing having workpiece engaging surface for engaging a workpiece, and an aperture in said workpiece engaging surface;
a motor mounted adjacent said aperture and comprising a stator non-rotatably mounted to the housing and a rotor arranged substantially coaxially around said stator and adapted to rotate relative to said stator when electrical power is supplied to the motor;
at least one blade mounted for rotation with said rotor and adapted to at least partially protrude from said aperture to engage a workpiece such that rotation of said rotor relative to said stator causes the or each blade to remove surface material from a workpiece; and
a rechargeable battery wherein the battery is adapted to be located, at least partially, above the workpiece engaging surface.

2. A planer according to claim 1, wherein the or each said blade is mounted to an external surface of the rotor.

3. A planer according to claim 1, further comprising a handle on the housing and an actuator adjacent said handle for supplying electrical power to the motor, wherein the centre of gravity of the planer is located below said actuator when the planer is held by and supported by said handle.

4. A planer according to claim 1, wherein the battery is adapted to be received at least partially inside the housing rearwardly of the motor.

5. A planer according to claim 1, wherein the rotor includes a plurality of ribs on an internal surface thereof to generate an airflow within the motor.

6. A planer according to claim 1, further comprising a fan mounted to the motor to generate an airflow to cool the motor and/or to move debris created by the cutting action of the rotating blade away from the rotor.

7. A planer according to claim 1, wherein the rotor comprises a substantially cylindrical drum and a plurality of permanent magnets attached to the inside of the drum.

8. A planer according to claim 7, wherein the permanent magnets comprise sintered rare earth magnets.

9. A planer according to claim 1, wherein the motor comprises a brushless shielded motor.

10. A planer according to claim 1, wherein the stator comprises a claw pole stator comprising at least one claw pole stator element.

11. A planer according to claim 10, wherein at least one said claw pole stator element comprises:
(i) a field coil;
(ii) a first half-claw member comprising a first central element and a plurality of claws arranged in equi-angular intervals around the perimeter of the first half-claw member; and
(iii) a second half-claw member comprising a second central element and a plurality of claws arranged in equi-angular intervals around the perimeter of the second half-claw member;
wherein the claw pole stator element is formed when the first half claw member and the second half claw member are joined at the first central element and the second central element thereby causing the claws to juxtapose about the perimeter of the first half-claw member and the second half-claw member, the claws enclosing the field coil and, the field coil surrounding the joined first central element and second central element.

12. A planer according to claim 11, wherein the first half-claw member and the second half-claw member comprise an isotropic ferromagnetic composite material.

13. A planer according to claim 10, wherein the claw pole stator further comprises a shaft and a plurality of claw pole stator elements coaxially disposed on the shaft.

14. A planer according to claim 13, wherein the shaft comprises a non-magnetic material.

15. A planer according to claim 1, wherein the stator comprises a laminated core having a plurality of laminated teeth, a field coil, and a shaft, wherein the laminated core is fixedly secured on the shaft.
